(19) United States
(12) Patent Application Publication
(10) Pub. No.: US 2026/0301407 A1
(43) Pub. Date: Oct. 1, 2026

(54) OCCLUSION-RESILIENT MULTI-CAMERA ACTION DETECTION AND RECOGNITION

(71) Applicant: Infosys Limited, Bangalore (IN)

(72) Inventors: Ramjee Rajasekaran, Bengaluru (IN); Sidharth Subhash Ghag, Pune (IN); Gowri A.S., Chennai (IN); Partha Goswami, Bengaluru (IN)

(73) Assignee: Infosys Limited, Bangalore, KA (IN)

(21) Appl. No.: 19/094,319

(22) Filed: Mar. 28, 2025

(30) Foreign Application Priority Data
Mar. 27, 2025 (IN) 202541029646

(51) Int. Cl. G06V 20/52; G06V 10/25; G06V 10/74; G06V 40/10; G06V 40/20

(52) U.S. Cl. CPC G06V 20/52; G06V 10/25; G06V 10/761; G06V 40/10; G06V 40/28

(57) ABSTRACT

An action detection and recognition technique is provided. A user is detected in video streams of multiple cameras. In each video stream, bounding boxes representing the user and products present in the video stream are generated. Using each video stream, an action performed by the user is detected. The action detection may involve extraction of user key-points, determination of proximity distances between the products and the user, determination of a state indicating whether a selected product is linked with the user, and tracking of the state for a trajectory sequence. Further, for the user, a weight is assigned to each camera based on the visibility of a user bounding box and the overlap of the user bounding box with other bounding boxes in the corresponding video stream. The action detected using the camera with the highest weight is designated to the user.

### FIELD OF THE DISCLOSURE

Various embodiments of the present disclosure relate generally to image processing. More specifically, various embodiments of the present disclosure relate to occlusion-resilient multi-camera action detection and recognition.

### BACKGROUND

Cameras have become ubiquitous in large facilities such as factories, warehouses, retail stores, and commercial complexes, for security, operational oversight, and quality control. In many of these applications, there is an increasing need to accurately detect actions performed by various individuals across multiple camera views to enhance monitoring and operational efficiency. Traditionally, this task has relied heavily on human operators, such as security personnel, who manually observe and analyze feeds from multiple cameras to identify individuals and detect and recognize their actions. However, this manual approach is not only labor-intensive and prone to fatigue but also susceptible to errors and inconsistencies, which may compromise the effectiveness of monitoring systems.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for occlusion-resilient multi-camera action detection and recognition are provided substantially as shown in, and described in connection with, at least one of the figures.

In an embodiment of the present disclosure, a system is disclosed. The system may include processing circuitry that is configured to detect a user in each of a plurality of video streams of a plurality of cameras. The processing circuitry is further configured to generate, using each of the plurality of video streams, a plurality of bounding boxes, with a first bounding box representing the user and a first set of bounding boxes representing a set of products present in the corresponding video stream. Further, the processing circuitry is configured to detect, using each of the plurality of video streams, an action associated with the user. To detect the action using a first video stream of the plurality of video streams, the processing circuitry is further configured to extract a plurality of key-points associated with the user, and determine, for the set of products present in the first video stream, a set of proximity distances between the first set of bounding boxes and a first key-point of the plurality of key-points. Based on the set of proximity distances, the processing circuitry is further configured to select at least a first product from the set of products. For the first product, the processing circuitry is further configured to determine a first state indicating whether the first product is linked with the user. The processing circuitry is further configured to track the first state for a trajectory sequence associated with the user. The action is detected based on the tracked first state. Further, the processing circuitry is configured to select one of the plurality of cameras based on a visibility of the first bounding box and an overlap associated with the first bounding box, in each video stream of the plurality of video streams. The processing circuitry is further configured to designate the action detected using the selected camera to the user.

In some embodiments, the action corresponds to one of a pick-up of the first product from a rack by the user or a putback of the first product on the rack by the user.

In some embodiments, the first key-point of the plurality of key-points corresponds to a knuckle of the user or a fingertip of the user.

In some embodiments, the first product is associated with a rack. The processing circuitry is further configured to determine whether a set of key-points, of the plurality of key-points, representing a hand of the user, is present within a region between an interaction line and the rack. The first state is determined and tracked based on the set of key-points being within the region between the interaction line and the rack.

In some embodiments, the trajectory sequence comprises a forward trajectory and a backward trajectory. The forward trajectory corresponds to movement of the set of key-points from the interaction line to the rack. The backward trajectory corresponds to movement of the set of key-points from the rack to the interaction line.

In some embodiments, the first product is linked with the user if the first product is present in the hand of the user. When the first product is absent in the hand of the user in the forward trajectory and present in the hand of the user in the backward trajectory, the action corresponds to a pick-up of the first product from the rack by the user. When the first product is present in the hand of the user in the forward trajectory and absent in the hand of the user in the backward trajectory, the action corresponds to a putback of the first product on the rack by the user.

In some embodiments, the first product is present in the hand of the user for at least a predefined time duration.

In some embodiments, the processing circuitry determines that the first product is in the hand of the user based on at least one of a proximity distance between a second bounding box, of the first set of bounding boxes, representing the first product and the first key-point being below a distance threshold, or an overlap between the second bounding box and the first bounding box being above an overlap threshold.

In some embodiments, the first video stream comprises a plurality of frames. The plurality of key-points are extracted and the set of proximity distances is determined for each frame of the plurality of frames. The processing circuitry is further configured to determine if the plurality of key-points are occluded across the plurality of frames, and normalize the occluded plurality of key-points based on at least one of an interpolation operation or a filtering operation. The first state is tracked for the trajectory sequence based on the normalized plurality of key-points across the plurality of frames and a temporal aggregation of the set of proximity distances determined for each frame of the plurality of frames.

In some embodiments, the processing circuitry is further configured to assign, for the user, a plurality of weights to the plurality of cameras, with a first weight assigned to a first camera that is associated with the first video stream. The first weight is assigned to the first camera based on (i) the visibility of the first bounding box in the first video stream, and (ii) the overlap of the first bounding box with one or more other bounding boxes of the plurality of bounding boxes in the first video stream. The processing circuitry selects one of the plurality of cameras based on the plurality of weights.

In some embodiments, the processing circuitry is further configured to detect, in the first video stream, a set of users that is different from the user. The plurality of bounding boxes further comprise a second set of bounding boxes for the detected set of users.

In some embodiments, a weight, of the plurality of weights, assigned to the selected camera is above a weight threshold.

In some embodiments, a weight assigned to the selected camera is the highest among the plurality of weights.

In some embodiments, a set of key-points, of the plurality of key-points, represents a hand of the user. The first weight is assigned to the first camera further based on a vantage point of the first camera with respect to an interaction of the hand of the user with the first product.

In some embodiments, the first weight is assigned to the first camera further based on an orientation of the hand of the user.

In some embodiments, a second bounding box, of the first set of bounding boxes, represents the first product. The first weight is assigned to the first camera further based on (i) a visibility of the second bounding box in the first video stream, and (ii) an overlap of the second bounding box with at least one other bounding box of the plurality of bounding boxes in the first video stream.

In some embodiments, the first weight is assigned to the first camera further based on a vantage point of the first camera with respect to the second bounding box.

In some embodiments, the plurality of video streams are synchronized using Network Time Protocol (NTP).

In some embodiments, a proximity distance of the set of proximity distances corresponds to a distance between a centroid of a bounding box of the first set of bounding boxes and the first key-point.

In some embodiments, the processing circuitry selects one of the plurality of cameras further based on a vantage point of each of the plurality of cameras with respect to an interaction of the user with the first product.

In some embodiments, the processing circuitry is further configured to re-identify the user, and associate, based on the action corresponding to a pick-up of the first product, the first product with a user account of the re-identified user.

In another embodiment of the present disclosure, a method is disclosed. The method comprises detecting, by processing circuitry, a user in each of a plurality of video streams of a plurality of cameras. The method further comprises generating, by the processing circuitry, using each of the plurality of video streams, a plurality of bounding boxes, with a first bounding box representing the user and a first set of bounding boxes representing a set of products present in the corresponding video stream. Further, the method comprises detecting, by the processing circuitry, using each of the plurality of video streams, an action associated with the user. The step of the detection of the action using a first video stream of the plurality of video streams further comprises extracting, by the processing circuitry, a plurality of key-points associated with the user, and determining, by the processing circuitry, for the set of products present in the first video stream, a set of proximity distances between the first set of bounding boxes and a first key-point of the plurality of key-points. Further, the step of the detection of the action comprises selecting, by the processing circuitry, based on the set of proximity distances, at least a first product from the set of products and determining, by the processing circuitry, for the first product, a first state indicating whether the first product is linked with the user. The step of the detection of the action further comprises tracking, by the processing circuitry, the first state for a trajectory sequence associated with the user. The action is detected based on the tracked first state. The method further comprises selecting, by the processing circuitry, one of the plurality of cameras based on a visibility of the first bounding box and an overlap associated with the first bounding box, in each video stream of the plurality of video streams. Further, the method comprises designating, by the processing circuitry, the action detected using the selected camera to the user.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an action detection and recognition environment, consistent with disclosed embodiments of the present disclosure;

FIG. 2 is a block diagram of processing circuitry of the action detection and recognition environment of FIG. 1, consistent with disclosed embodiments of the present disclosure;

FIG. 3 represents an example scenario of an action detection and recognition technique, consistent with disclosed embodiments of the present disclosure;

FIGS. 4A-4C, collectively, represents a flowchart that illustrates a method for action detection and recognition, consistent with disclosed embodiments of the present disclosure; and

FIG. 5 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, to accurately detect user actions in large multi-camera facilities, action detection and recognition models may be employed. These models are deep learning systems that analyze both the spatial details in individual video frames and the temporal dynamics across sequences to classify user actions. These models typically combine convolutional neural networks (CNNs) for robust feature extraction with temporal models (e.g., recurrent neural networks (RNNs) or Transformers) that capture motion and contextual relationships over time. While these models are effective in controlled or static environments, they encounter significant challenges in dynamic and crowded settings (such as retail stores). For example, in crowded stores, the accuracy of these models may degrade due to occlusions (e.g., when users or products are partially hidden). Further, in some cases, the models may fail to distinguish between multiple users in overlapping or occluded scenarios. Additionally, multiple cameras may provide conflicting observations, leading to inconsistent action recognition. These limitations make conventional approaches vulnerable to false positives, especially in dynamic and crowded settings.

The present disclosure addresses the above limitations by providing a system and a method that uses occlusion-resilient multi-camera action detection and recognition techniques. In the present disclosure, a user is detected in video streams of multiple cameras. These video streams are synchronized using Network Time Protocol (NTP). Using each video stream, various bounding boxes are generated, with a user bounding box representing the user, various product bounding boxes representing products present in the video stream, and other user bounding boxes representing other users present in the video stream. Further, using each video stream, an action performed by the user is detected.

The action detection may involve extraction of various key-points of the user. In an example, 34 human key-points are extracted. For the products, proximity distances are determined between the product bounding boxes and a key-point corresponding to a knuckle or a fingertip of the user. Based on the proximity distances, one product is selected to be nearest to the user. The product may be placed on a rack. For the selected product, a state is determined. The state may indicate whether the selected product is linked with the user. The state may be determined based on the proximity distance between the product bounding box and the knuckle or fingertip key-point being below a distance threshold, or an overlap between the product bounding box and the user bounding box being above an overlap threshold. Further, the state is tracked for a trajectory sequence associated with the user. The state may be determined and tracked exclusively when a hand of the user is present within a region between an interaction line and the rack. In a multi-camera environment (e.g., a retail store), the relevant user actions are typically associated with users picking up products from racks or putting back products on the racks. Thus, in the present disclosure, the interaction line may demarcate zones near the rack where user-product interactions are likely to occur. The trajectory sequence may include a forward trajectory (e.g., movement of the hand from an interaction line to a rack), and a backward trajectory (e.g., movement of the hand from the rack to the interaction line).

The action may be detected using each video stream based on the tracked state associated with the corresponding video stream. For example, when the product is absent in the hand in the forward trajectory and present in the hand in the backward trajectory, the action corresponds to a pick-up of the product from the rack. Conversely, when the product is present in the hand in the forward trajectory and absent in the hand in the backward trajectory, the action corresponds to a putback of the product on the rack.

Further, for the user, a weight is assigned to each camera based on the visibility of the user bounding box in the corresponding video stream, the overlap of the user bounding box with other user or product bounding boxes in the corresponding video stream, and a vantage point of the camera with respect to the interaction of the hand with the product. A camera with the highest weight is then selected, and the action detected using the selected camera is designated to the user.

The action detection and recognition technique of the present disclosure thus uniquely combines synchronized multi-camera inputs, fine-grained key-point detection, trajectory analysis, and camera weighting to overcome the limitations of existing solutions, thereby providing a robust and scalable system for occlusion-resilient multi-camera action detection in dynamic and crowded settings. As the video streams are synchronized using NTP, consistency across all cameras is ensured, enabling accurate analysis of actions from multiple perspectives. Further, the utilization of 34 human key-points for fine-grained analysis of hand movements and their association with nearby products improves the accuracy of the action detection.

Additionally, assigning weights to each camera ensures that the camera with a better vantage point is selected for the action recognition, thereby further improving detection and recognition in occlusion scenarios. The use of multiple cameras with weights may also accurately differentiate between multiple users interacting in the same scene. Further, the state is determined and tracked only when the user's hand passes the interaction line, thereby saving significant computational power. The action detection and recognition technique of the present disclosure thus significantly reduces the false positive detections as compared to conventional approaches. The application area of the present disclosure may include any domain that utilizes action detection and recognition systems. It is appreciated that the human mind is not equipped to conceptualize and engineer accurate, effective, and dynamic occlusion-resilient action detection and recognition in multi-camera facilities such as retail stores, airports, or the like, given the digital interconnectedness of action detection and recognition systems.

### FIGURE DESCRIPTION

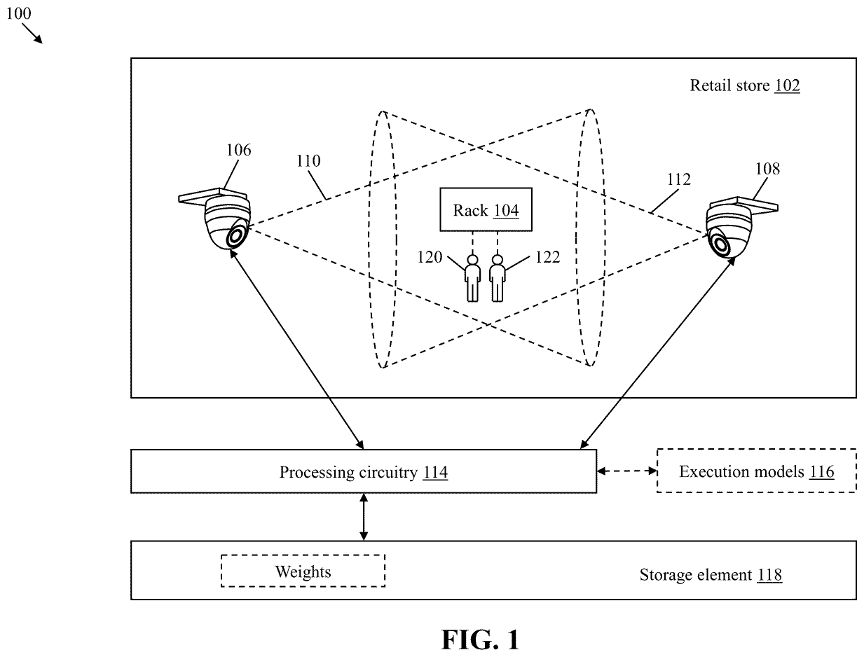

FIG. 1 is a schematic diagram that illustrates an action detection and recognition environment 100, consistent with disclosed embodiments of the present disclosure. The action detection and recognition environment 100 (hereinafter referred to as the “environment 100”) includes a retail store 102. The retail store 102 may include a plurality of racks, of which a rack 104 is shown. The rack 104 may have various shelves for displaying objects (e.g., products of different brands and types).

The retail store 102 may include a plurality of cameras, of which cameras 106 and 108 are shown. The cameras 106 and 108 are positioned in close proximity to the rack 104 to capture a video of the rack 104 (e.g., various objects placed on the rack 104). The cameras 106 and 108 have field-of-views (FOVs) 110 and 112, respectively, that define the extent of the observable scene captured by the lens. In other words, the cameras 106 and 108 may be configured to continuously capture a video of the associated FOVs 110 and 112, respectively. The placement of the cameras 106 and 108 may be such that the rack 104 is within the FOVs 110 and 112, respectively.

In large facilities (such as the retail store 102), cameras (such as the cameras 106 and 108) are integral for supporting security, operational oversight, and quality control. In the retail stores (such as the retail store 102), there is an increasing need to accurately detect actions performed by various individuals across multiple camera views to accurately link purchases to users. Traditionally, human operators manually monitored feeds from these cameras to identify individuals and detect their actions—a process that is labor-intensive, error-prone, and inconsistent. To address these challenges, deep learning-based action detection and recognition models have been deployed. Although effective in controlled settings, these models often struggle in dynamic, crowded environments due to issues like occlusions, overlapping individuals, and conflicting observations from multiple cameras, which can lead to false positives.

To overcome these challenges, an action detection and recognition technique is disclosed in the present disclosure. To facilitate such an action detection and recognition technique, the environment 100 may further include processing circuitry 114, execution models 116, and a storage element 118. The processing circuitry 114, the execution models 116, and the storage element 118 may collectively execute the action detection and recognition technique of the present disclosure. In an embodiment, the execution models 116 may be stored in the storage element 118 or different storage circuitry associated with the processing circuitry 114. The action detection and recognition technique of the present disclosure is utilized to process video streams of the rack 104 captured by the cameras 106 and 108 to detect and recognize various actions performed by users present therein. The actions may correspond to a pick-up of a product from the rack 104, a putback of the product on the rack 104, a putback of one product from the rack 104 and a pick-up of a different product from the rack 104, a pick-up of one product from the rack 104 and a putback of a different product on the rack 104, or the like.

The processing circuitry 114 may be coupled to the cameras 106 and 108 and the storage element 118. The processing circuitry 114 may include suitable logic, circuitry, interfaces, and/or code, executable by the circuitry, that may be configured to facilitate the action detection and recognition technique in the retail store 102. In an embodiment, the processing circuitry 114 may be an edge computing device to ensure low-latency processing.

The processing circuitry 114 may be configured to receive the video streams captured by the cameras 106 and 108. The video streams may be synchronized using Network Time Protocol (NTP) to ensure temporal consistency across the cameras 106 and 108. In an embodiment, the processing circuitry 114 may be configured to synchronize the video streams using NTP. The processing circuitry 114 may be further configured to process each time-aligned video stream to detect one or more users and one or more products present therein. In an example, the processing circuitry 114 may be configured to detect users 120 and 122 and a set of products (not shown) in the video streams of the cameras 106 and 108. Further, using each video stream, the processing circuitry 114 may be configured to generate a bounding box representing each detected object. In other words, the processing circuitry 114 may be configured to generate first and second user bounding boxes representing the users 120 and 122, respectively, and a set of product bounding boxes representing the set of products. Further, the processing circuitry 114 may be configured to track the bounding boxes of the users 120 and 122 and the set of products to maintain associations therebetween.

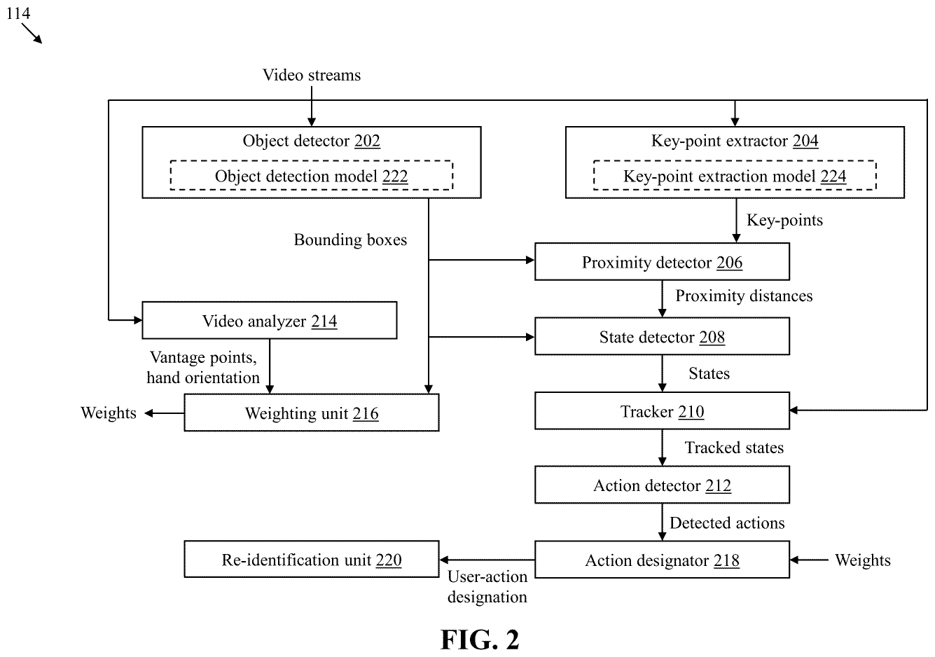

The processing circuitry 114 may detect the users 120 and 122 and the set of products and generate the bounding boxes for the same using one of the execution models 116. The execution models 116 may include various artificial intelligence (AI) models that are utilized by the processing circuitry 114 for the execution of the action detection and recognition technique of the present disclosure. For the detection of the users 120 and 122 and the set of products and the generation of the bounding boxes, the execution models 116 may include an object detection model. In an embodiment, the object detection model may be trained using annotated datasets of retail environments. The object detection model is explained in detail in FIG. 2.

The processing circuitry 114 may be further configured to detect, using each video stream, an action associated with each of the users 120 and 122. For the sake of brevity, the action detection is explained for the user 120. However, the action performed by the user 122 may be detected in a manner similar to the action detection of the user 120.

### Action Detection:

The processing circuitry 114 may be further configured to extract a plurality of key-points associated with the user 120 using the video stream of the camera 106. The key-points may indicate various points of the body of the user 120 that can be utilized for tracking the user 120 and actions associated with the user 120. Thus, the extracted key-points may include a key-point corresponding to a knuckle of the user 120, a key-point corresponding to a fingertip of the user 120, a set of key-points representing a hand of the user 120, or the like. The key-point corresponding to the knuckle of the user 120 is hereafter referred to as the “knuckle key-point”, the key-point corresponding to the fingertip of the user 120 is hereafter referred to as the “fingertip key-point”, and the set of key-points representing the hand of the user 120 is hereinafter referred to as the “hand key-points”. The processing circuitry 114 may extract the key-points associated with the user 120 using one of the execution models 116. For the extraction of the key-points, the execution models 116 may include a key-point extraction model. The key-point extraction model is explained in detail in FIG. 2.

The processing circuitry 114 may be further configured to determine a proximity distance between a product and one of the key-points of the user 120. In an embodiment, the key-point being utilized for proximity distance determination may be the knuckle or fingertip key-point. Thus, the processing circuitry 114 may be further configured to determine, for the set of products, using the video stream of the camera 106, a set of proximity distances between the set of product bounding boxes and the knuckle or fingertip key-point. In an embodiment, a proximity distance corresponds to a distance between a centroid of a bounding box of the set of product bounding boxes and the knuckle or fingertip key-point. The proximity distances may indicate which products are near to the user 120. Thus, based on the set of proximity distances, the processing circuitry 114 may be further configured to select at least a first product from the set of products. In an example, the first product may be the closest to the user 120 (e.g., has the lowest proximity distance).

The processing circuitry 114 may be further configured to determine, for the first product, using the video stream of the camera 106, a first state indicating whether the first product is linked with the user 120. In an embodiment, the first state may correspond to the first product being in the hand of the user 120 or absent in the hand of the user 120. Thus, the first product may be linked with the user 120 if the first product is present in the hand of the user 120.

The processing circuitry 114 may determine the first state based on at least one of a first proximity distance between a first product bounding box representing the first product and the knuckle or fingertip key-point and an overlap between the first product bounding box and the first user bounding box. In an embodiment, the processing circuitry 114 may determine that the first product is present in the hand of the user 120 based on the first proximity distance being below a distance threshold, the overlap between the first product bounding box and the first user bounding box being above an overlap threshold, or a combination thereof. Conversely, the processing circuitry 114 may determine that the first product is absent in the hand of the user 120 based on the first proximity distance being equal to or above the distance threshold, the overlap between the first product bounding box and the first user bounding box being equal to or below the overlap threshold, or a combination thereof. In an example, the distance threshold may be 5 centimeters and the overlap threshold may be 0.7 (e.g., 70%). However, in other embodiments, the values of the distance threshold and the overlap threshold may be different.

The processing circuitry 114 may be further configured to track, using the video stream of the camera 106, the first state for a trajectory sequence associated with the user 120. The trajectory sequence may include a forward trajectory and a backward trajectory. The forward trajectory may correspond to movement of the hand key-points from an interaction line to the rack 104, whereas the backward trajectory may correspond to movement of the hand key-points from the rack 104 to the interaction line.

In retail stores (such as the retail store 102), the relevant user actions are typically associated with users picking up products from racks (such as the rack 104) or putting back products on the racks. Thus, in the present disclosure, an interaction line is considered in the retail store 102 for optimizing the efficient use of computational resources. The interaction line may be configured to demarcate zones near the rack 104 where user-product interactions are likely to occur. The interaction line may be at a predefined distance from the rack 104. In an example, the interaction line may be at a distance of 1 meter from the rack 104. However, in other embodiments, the interaction line may be at varying distances from the rack 104. A region between the interaction line and the rack 104 is considered a region-of-interest for action detection operations. Thus, the processing circuitry 114 may be further configured to determine whether the hand key-points are present within the region between the interaction line and the rack 104, and the first state is determined and tracked exclusively based on the hand key-points being within the region between the interaction line and the rack 104. This may save significant computational power.

The action performed by the user 120 is detected based on the tracked first state. The detected action may correspond to one of a pick-up of the first product from the rack 104 by the user 120 or a putback of the first product on the rack 104 by the user 120. In an embodiment, when the first product is absent in the hand of the user 120 in the forward trajectory and present in the hand of the user 120 in the backward trajectory, the action corresponds to the pick-up of the first product from the rack 104 by the user 120. Conversely, when the first product is present in the hand of the user 120 in the forward trajectory and absent in the hand of the user 120 in the backward trajectory, the action corresponds to the putback of the first product on the rack 104 by the user 120.

In an embodiment, each video stream may include a plurality of frames, and the key-points are extracted and the proximity distances are determined for each frame. The processing circuitry 114 may be further configured to determine if the plurality of key-points are occluded across the plurality of frames. If the key-points are occluded, the forward and backward trajectories are required to be normalized. In such cases, the processing circuitry 114 may be further configured to normalize the occluded plurality of key-points based on at least one of an interpolation operation or a filtering operation. The interpolation operation may correspond to a linear or spline interpolation. The interpolation operation may be utilized to fill gaps for missing key-points. The filtering operation may correspond to a moving average filtering or a Kalman filtering. The filtering operation may be utilized to smoothen abrupt transitions, thereby normalizing trajectories. In an embodiment, the first state is tracked for the trajectory sequence based on the normalized plurality of key-points across the plurality of frames and a temporal aggregation of the set of proximity distances determined for each frame of the plurality of frames. Thus, during the trajectory sequence tracking, if any key-points are occluded, the aforementioned hierarchical aggregation can be utilized to fill the gaps and smoothen abrupt transitions, thereby ensuring that the correct action is detected using the tracked first state. The hierarchical aggregation may thus ensure robust action recognition even when key-points are intermittently occluded.

The interaction between the user 120 and a single product (e.g., the first product) is described in FIG. 1 to keep the description concise and clear and should not be considered a limitation of the present disclosure. In numerous embodiments, the user 120 may interact with multiple products. In such cases, the action may correspond to the pick-up or putback of multiple products, a putback of one product from the rack 104 and a pick-up of a different product from the rack 104, a pick-up of one product from the rack 104 and a putback of a different product on the rack 104, or the like.

The action associated with the user 120 is thus detected using the video stream of the camera 106. As the user 120 is also detected in the video stream of the camera 108, the processing circuitry 114 may also be configured to detect the action associated with the user 120 using the video stream of the camera 108 in a similar manner as described above. Camera selection:

The processing circuitry 114 may be further configured to select one of the cameras 106 and 108 for the recognition of the action of the user 120. For the user 120, the processing circuitry 114 may be configured to assign first and second weights to the cameras 106 and 108, respectively. A weight may be assigned to a camera based on the visibility of various objects (e.g., users and products) and overlap therebetween in the video stream captured by the corresponding camera. In an embodiment, the processing circuitry 114 may be further configured to store the first and second weights in the storage element 118.

In an embodiment, the processing circuitry 114 may be further configured to determine a visibility of the first user bounding box in the video stream of the camera 106. The visibility may define an area of the first user bounding box that is visible in the video stream of the camera 106. The processing circuitry 114 may be further configured to determine an overlap of the first user bounding box with one or more other bounding boxes in the video stream of the camera 106. The one or more other bounding boxes may correspond to product bounding boxes or other user bounding boxes. The processing circuitry 114 may assign the first weight to the camera 106 based on the visibility of the first user bounding box in the video stream of the camera 106, and the overlap of the first user bounding box with one or more other bounding boxes in the video stream of the camera 106. The first weight may be assigned to the camera 106 using equation (1) shown below:

$$W 1 = \frac{Visible area}{Visible area + Occlusion quotient} \qquad ( 1 )$$

where,
Visible area indicates the visibility of the first user bounding box in the video stream of the camera 106, and
Occlusion quotient corresponds to a ratio of (i) the overlap of the first user bounding box with the other bounding boxes in the video stream of the camera 106 and (ii) the total area of the first user bounding box.

Thus, the cameras with higher visibility are assigned higher weights.

The scope of the present disclosure is not limited to the aforementioned assignment of weights. In several embodiments, the first weight may be assigned to the camera 106 based on a vantage point of the camera 106 with respect to an interaction of the hand of the user 120 with the first product. In other words, the camera's vantage point may play an important role in determining how clearly the interaction is captured. In such a scenario, the first weight may be assigned to the camera 106 using equation (2) shown below:

$$W 1 = ( α * \frac{Visible area}{Visible area + Occlusion quotient} ) + ( β * cos {θ}_{1} ) \qquad ( 2 )$$

where,
θ₁ is the angle between the line of sight of the camera 106 and the interaction of the hand of the user 120 with the first product, and
α and β are factors dynamically assigned to the visibility and vantage parameters, respectively.

In numerous embodiments, the first weight may be assigned to the camera 106 further based on an orientation of the hand of the user 120. The orientation may indicate whether the user 120 is using a left hand or a right hand. For example, if the camera 106 is on the right hand side of the user 120 and the user 120 is using the right hand to interact with the products on the rack 104, the camera 106 is assigned a higher weight as compared to scenarios where the user 120 uses the left hand. In such a scenario, the first weight may be assigned to the camera 106 using equation (3) shown below:

$$W 1 = ( α * \frac{Visible area}{Visible area + Occlusion quotient} ) + ( β * cos {θ}_{2} ) \qquad ( 3 )$$

where,
θ₂ is the angle between the vector from the camera 106 to the hand bounding box centroid and the normal vector to the interaction plane.

The element “cos θ” may have a negative value, an approximately zero-value, or a value approximately equal to 1. cos θ being approximately equal to 1 may indicate that the camera 106 is well-aligned to capture the interacting hand directly. cos θ being approximately equal to 0 may indicate that the camera 106 captures the interaction from a perpendicular angle, and hence, may contribute less to the detection. cos θ being less than 1 may indicate that the camera 106 is poorly positioned and the contribution may be minimized.

The scope of the present disclosure is not limited to the visibility of users being utilized for camera weight assignment. In additional embodiments, the first weight may be assigned to the camera 106 further based on the visibility of the first product bounding box in the video stream of the camera 106, and the overlap of the first product bounding box with at least one other product or user bounding box in the video stream captured by the camera 106. In such a scenario, the first weight may be assigned to the camera 106 using equation (4) shown below:

$$W 1 = ( γ * \frac{Visible area}{Visible area + Occlusion quotient} ) + ( δ * \frac{1}{First proximity distance} ) \qquad ( 4 )$$

where,
Visible area indicates the visibility of the first product bounding box in the video stream of the camera 106,
Occlusion quotient corresponds to a ratio of (i) the overlap of the first product bounding box with the other bounding boxes in the video stream of the camera 106 and (ii) the total area of the first product bounding box, and
γ, δ, are factors dynamically assigned to the visibility and proximity parameters, respectively.

The first weight may be assigned to the camera 106 further based on a vantage point of the camera 106 with respect to the first product bounding box in a similar manner as described above.

The first weight is thus dynamically assigned to the camera 106 based on various parameters. These parameters, individually or in combination, ensure that cameras are weighted based on their ability to capture the interaction clearly. The second weight may be assigned to the camera 108 in a similar manner as described above.

The processing circuitry 114 may thus select one of the cameras 106 and 108 based on the first and second weights. In an embodiment, the weight assigned to the selected camera is the highest among the first and second weights. In another embodiment, the weight assigned to the selected camera is above a weight threshold. In an example, the weight threshold may be equal to 0.6 (e.g., 60%). However, the weight threshold may have different values in other embodiments. The weight threshold ensures that if both the cameras are not capturing the user 120 sufficiently (e.g., the weights are below the weight threshold), none of the cameras can be utilized for detecting and recognizing user actions, thereby reducing false detections. In such a scenario, the action recognition may be performed by an administrator of the retail store 102 who is presented with the video streams of the cameras 106 and 108 on a corresponding administrator device (not shown). Conversely, if both the first and second weights are above the weight threshold, the selected camera may be the camera with the highest weight among the first and second weights.

The processing circuitry 114 may be further configured to designate the action detected using the selected camera to the user 120. If the actions detected for the user 120 by both the cameras 106 and 108 are the same, the weights may be utilized to verify the confidence level of the detected actions. If the actions detected for the user 120 by both the cameras 106 and 108 are different, the camera with the higher weight (provided the weight is above the weight threshold) may be selected and the action detected by the selected camera is designated to the user 120. The processing circuitry 114 may be further configured to designate actions to the user 122 in a similar manner as described above for the user 120.

The action detection and recognition technique of the present disclosure thus uniquely combines synchronized multi-camera inputs, fine-grained key-point detection, trajectory analysis, and camera weighting to overcome the limitations of existing solutions, thereby providing a robust and scalable system for occlusion-resilient multi-camera action detection in dynamic and crowded settings. As the video streams are synchronized using NTP, consistency across the cameras 106 and 108 is ensured, enabling accurate analysis of actions from multiple perspectives. Further, the utilization of 34 human key-points for fine-grained analysis of hand movements and their association with nearby products improves the accuracy of the action detection. Additionally, assigning weights to each camera ensures that the camera with a better vantage point is selected for the action recognition, thereby further improving detection and recognition in occlusion scenarios. The use of multiple cameras with weights may also accurately differentiate between multiple users interacting in the same scene.

The use of a bounding box-based approach for assessing visibility and occlusion is more computationally efficient than pixel-level analysis widely used in conventional action detection systems. The bounding box-based occlusion handling is significantly more efficient than pixel-level analysis, as it abstracts visibility and occlusion to object-level interactions. For example, instead of processing millions of pixels in every frame, the overlap between bounding boxes and visibility percentages of bounding boxes are evaluated, thereby optimizing the use of computational resources. Additionally, the bounding box-based approach is faster and more scalable than the pixel-level approach, enabling the handling of multiple cameras and users in real-time. Such handling is critical in retail environments where latency directly impacts usability. Bounding boxes focus on object-level relationships (e.g., hand-product interactions), aligning directly with action detection goals. This reduces noise and irrelevant data compared to pixel-level methods, improving decision-making accuracy. Further, the bounding box-based approach scales efficiently with the number of cameras and users, as the complexity grows linearly with the number of detected objects. Pixel-level methods, by contrast, face exponential growth in computational demand. Further, by dynamically weighting cameras based on bounding box visibility, reliable observations are prioritized, ensuring that occlusions do not compromise action detection accuracy. Bounding box-based tracking integrates naturally with forward-backward trajectory analysis, enabling full-sequence action classification. The bounding boxes act as anchors for associating key-points and maintaining user-product relationships across frames. In retail environments, actions like pick-up and putback are inherently tied to spatial relationships between hands and products. The bounding box method simplifies these relationships.

The integration of bounding box-based occlusion handling and utilization of dynamic weighted camera observations to drive action recognition ensures robust detection even under challenging conditions with frequent occlusions. Further, the state of a product is determined and tracked only when the user's hand passes the interaction line, thereby saving significant computational power. Additionally, by defining a complete interaction sequence (e.g., from the interaction line to rack 104 and back), the action detection and recognition technique of the present disclosure eliminates false positives from transient movements, providing robustness that frame-based methods may not achieve. For example, flickering (e.g., when a user quickly moves their hand in and out of the interaction line) is addressed in the present disclosure via two methodologies. For example, in several embodiments, the first product is considered to be present in the hand of the user 120 if the first product is detected to be present in the hand of the user 120 for at least a predefined time duration. Further, the processing circuitry 114 may be configured to filter unreliable or erratic video frames using the weights assigned to the corresponding cameras. These two methodologies ensure that the flickering is addressed and does not lead to false detections.

The action detection and recognition technique of the present disclosure provides hierarchical temporal-spatial aggregation that ensures consistent action recognition. The hierarchical temporal-spatial aggregation combines frame-level validation (e.g., proximity distances and state are validated spatially in each frame) and trajectory analysis (e.g., temporal trends in forward and backward movements are aggregated to detect consistent patterns). This two-tier reasoning eliminates ambiguities caused by transient movements or partial occlusions, improving the reliability of pick-up and putback classifications. Further, in overlapping interactions, the action detection and recognition technique of the present disclosure environments leverages bounding box associations to track users and products independently and applies key-point trajectory analysis to assign actions uniquely to each user. This ensures no ambiguity in associating actions to users, even in crowded scenarios. The action detection and recognition technique of the present disclosure thus significantly reduces the false positive detections as compared to conventional approaches.

The processing circuitry 114 may be further configured to re-identify the user 120 using one or more re-identification techniques. Based on the re-identification, various operations associated with the user 120 may be executed. For example, a user account may be maintained for each user present in the retail store 102, and based on the successful re-identification and the action corresponding to a pick-up of the first product, the processing circuitry 114 may be further configured to associate the first product with the user account of the re-identified user 120. In such a scenario, all items picked up by the user 120 may be directly linked to the user account. At a billing counter of the retail store 102, all items linked to the user account may be billed to the user 120. In the retail store 102, the action detection and recognition technique of the present disclosure may also be utilized for facilitating real-time inventory management by logging product movements, enhancing theft detection by monitoring unregistered product pick-ups, improving store security by monitoring employee-customer interactions, deriving insights into customer shopping behavior (e.g., product engagement, preferences, and time spent in aisles), enabling targeted marketing and personalized promotions based on shopping patterns, or the like. The accurate action detection and recognition technique of the present disclosure ensures that the aforementioned operations are executed in an optimal, accurate, and effective manner.

The scope of the present disclosure is not limited to the action detection and recognition technique being implemented in the retail store 102. In numerous embodiments, the action detection and recognition technique of the present disclosure may be implemented in any scenario where user actions are tracked over time, even when they occlude with other objects in the video streams. In one example, the action detection and recognition technique of the present disclosure may be implemented in logistics and warehousing for tracking product handling during inventory stocking, packaging, or order picking processes, for enhancing automation in distribution centers by monitoring human-robot collaboration, or the like. In another example, the action detection and recognition technique of the present disclosure may be implemented in healthcare and rehabilitation for monitoring human movement in physical therapy or rehabilitation scenarios. In yet another example, the action detection and recognition technique of the present disclosure may be implemented in sports analytics to monitor athletes' actions, evaluate performance, or detect infractions during gameplay.

The retail store 102 is shown to include one rack (e.g., the rack 104), two users (e.g., the users 120 and 122), and two cameras (e.g., the cameras 106 and 108) to keep the illustration and description concise and clear and should not be considered a limitation of the present disclosure. In several embodiments, a section of the retail store 102 may include more than two cameras covering multiple racks, with more than two users shopping in the corresponding zone. In such scenarios, an action is detected for each user using each camera in the manner described above, with visibility of the user, occlusions between various products and other users, and overlap between user-product interactions of various users, being considered for selecting the camera with the better vantage point.

FIG. 2 is a block diagram of the processing circuitry 114, consistent with disclosed embodiments of the present disclosure. As illustrated in FIG. 2, the processing circuitry 114 may include an object detector 202, a key-point extractor 204, a proximity detector 206, a state detector 208, a tracker 210, an action detector 212, a video analyzer 214, a weighting unit 216, an action designator 218, and a re-identification unit 220.

The object detector 202 may be coupled to the cameras 106 and 108. The object detector 202 may include suitable logic, circuitry, interfaces, and/or code, executable by the circuitry, that may be configured to perform one or more operations. For example, the object detector 202 may be configured to receive the video streams captured by the cameras 106 and 108. The object detector 202 may be further configured to process each video stream to detect the users 120 and 122 and the set of products in the video streams of the cameras 106 and 108. Further, in each video stream, the object detector 202 may be configured to generate the first and second user bounding boxes representing the users 120 and 122, respectively, and the set of product bounding boxes representing the set of products. Further, the object detector 202 may be configured to track the bounding boxes of the users 120 and 122 and the set of products to maintain associations therebetween.

The object detector 202 may detect the users 120 and 122 and the set of products and generate the bounding boxes for the same using an object detection model 222. The object detection model 222 may be trained using annotated datasets of retail environments. The object detection model 222 may be a subset of computer vision algorithms designed to identify and locate multiple objects within an image or a video. The object detection model 222 may use deep learning architectures, such as convolutional neural networks (CNNs) and transformer-based networks, to extract spatial features and classify objects while predicting bounding box coordinates. Examples of the object detection model 222 may include faster region-based CNN, you only look once (YOLO), and single shot multibox detector (SSD).

The key-point extractor 204 may be coupled to the cameras 106 and 108. The key-point extractor 204 may include suitable logic, circuitry, interfaces, and/or code, executable by the circuitry, that may be configured to perform one or more operations. For example, the key-point extractor 204 may be configured to receive the video streams captured by the cameras 106 and 108. Further, the key-point extractor 204 may be configured to extract the plurality of key-points associated with a user (e.g., the user 120) using a video stream (e.g., the video stream of the camera 106). The key-points may indicate various points of the body of the user 120 that can be utilized for tracking the user 120 and actions associated with the user 120. The key-point extractor 204 may extract the key-points using a key-point extraction model 224. The key-point extraction model 224 is a class of computer vision algorithms designed to detect and localize specific landmark points on objects, such as facial key-points, human body joints, or object features. The key-point extraction model 224 may leverage deep learning architectures to learn spatial representations and predict precise coordinate locations. Examples of the key-point extraction model 224 may include open-source pose estimation (OpenPose), high-resolution network (HRNet), deep learning-based pose estimation (DeepPose), or the like.

The proximity detector 206 may be coupled to the object detector 202 and the key-point extractor 204. The proximity detector 206 may include suitable logic, circuitry, interfaces, and/or code, executable by the circuitry, that may be configured to perform one or more operations. For example, the proximity detector 206 may be configured to receive the bounding boxes and the extracted key-points from the object detector 202 and the key-point extractor 204, respectively. The proximity detector 206 may be further configured to determine a proximity distance between a product and one of the key-points of the user 120. In an embodiment, the key-point being utilized for proximity distance determination may be the knuckle or fingertip key-point. Thus, the proximity detector 206 may be further configured to determine, for the set of products present in the video stream of the camera 106, the set of proximity distances between the set of product bounding boxes and the knuckle or fingertip key-point.

The state detector 208 may be coupled to the object detector 202 and proximity detector 206. The state detector 208 may include suitable logic, circuitry, interfaces, and/or code, executable by the circuitry, that may be configured to perform one or more operations. For example, the state detector 208 may be configured to receive the bounding boxes and the set of proximity distances from the object detector 202 and the proximity detector 206, respectively. Based on the set of proximity distances, the state detector 208 may be further configured to select the first product from the set of products. In an example, the first product may be the closest to the user 120 (e.g., has the lowest proximity distance). The state detector 208 may be further configured to determine, for the first product, using the video stream of the camera 106, the first state indicating whether the first product is linked with the user 120. The first state may be determined based on at least one of the first proximity distance between the first product bounding box representing the first product and the knuckle or fingertip key-point and the overlap between the first product bounding box and the first user bounding box. In an embodiment, the first product is present in the hand of the user 120 based on the first proximity distance being below the distance threshold, the overlap between the first product bounding box and the first user bounding box being above the overlap threshold, or a combination thereof. Conversely, the first product is absent in the hand of the user 120 based on the first proximity distance being equal to or above the distance threshold, the overlap between the first product bounding box and the first user bounding box being equal to or below the overlap threshold, or a combination thereof.

The tracker 210 may be coupled to the state detector 208 and the cameras 106 and 108. The tracker 210 may include suitable logic, circuitry, interfaces, and/or code, executable by the circuitry, that may be configured to perform one or more operations. For example, the tracker 210 may be configured to receive the video streams captured by the cameras 106 and 108. The tracker 210 may be further configured to track, using the video stream of the camera 106, the first state detected by the state detector 208 for the trajectory sequence associated with the user 120. The trajectory sequence may include the forward trajectory and the backward trajectory.

The action detector 212 may be coupled to the tracker 210. The action detector 212 may include suitable logic, circuitry, interfaces, and/or code, executable by the circuitry, that may be configured to perform one or more operations. For example, the action detector 212 may be configured to receive the first state tracked for the trajectory sequence. The action detector 212 may be further configured to detect the action performed by the user 120 based on the tracked first state. The detected action may correspond to one of a pick-up of the first product from the rack 104 by the user 120 or a putback of the first product on the rack 104 by the user 120. In an embodiment, when the first product is absent in the hand of the user 120 in the forward trajectory and present in the hand of the user 120 in the backward trajectory, the action corresponds to the pick-up of the first product from the rack 104 by the user 120. Conversely, when the first product is present in the hand of the user 120 in the forward trajectory and absent in the hand of the user 120 in the backward trajectory, the action corresponds to the putback of the first product on the rack 104 by the user 120.

The action associated with the user 120 is thus detected using the video stream of the camera 106. As the user 120 is also detected in the video stream of the camera 108, the object detector 202, the key-point extractor 204, the proximity detector 206, the state detector 208, the tracker 210, and the action detector 212 may also be configured to detect the action associated with the user 120 using the video stream of the camera 108 in a similar manner as described above.

The video analyzer 214 may be coupled to the cameras 106 and 108. The video analyzer 214 may include suitable logic, circuitry, interfaces, and/or code, executable by the circuitry, that may be configured to perform one or more operations. For example, the video analyzer 214 may be configured to receive the video streams captured by the cameras 106 and 108. The video analyzer 214 may be further configured to process each video stream to detect hand orientations of the users 120 and 122 and the vantage points of the cameras 106 and 108.

The weighting unit 216 may be coupled to the object detector 202, the video analyzer 214, and the storage element 118. The weighting unit 216 may include suitable logic, circuitry, interfaces, and/or code, executable by the circuitry, that may be configured to perform one or more operations. For example, the weighting unit 216 may be configured to receive the bounding boxes from the object detector 202. Further, the weighting unit 216 may be configured to receive the detected hand orientations of the users 120 and 122 and the detected vantage points of the cameras 106 and 108 from the video analyzer 214.

In an embodiment, the weighting unit 216 may be further configured to determine the visibility of the first user bounding box in the video stream of the camera 106. The weighting unit 216 may be further configured to determine the overlap of the first user bounding box with one or more other bounding boxes in the video stream of the camera 106. The weighting unit 216 may be further configured to assign the first weight to the camera 106 based on the visibility of the first user bounding box in the video stream of the camera 106, and the overlap of the first user bounding box with one or more other bounding boxes in the video stream of the camera 106. In several embodiments, the first weight may be assigned to the camera 106 based on the vantage point of the camera 106 with respect to the interaction of the hand of the user 120 with the first product. In numerous embodiments, the first weight may be assigned to the camera 106 further based on the orientation of the hand of the user 120. In additional embodiments, the first weight may be assigned to the camera 106 further based on the visibility of the first product bounding box in the video stream of the camera 106, and the overlap of the first product bounding box with at least one other product or user bounding box in the video stream captured by the camera 106. The first weight may be assigned to the camera 106 further based on a vantage point of the camera 106 with respect to the first product bounding box.

The first weight is thus dynamically assigned to the camera 106 based on various parameters. These parameters, individually or in combination, ensure that cameras are weighted based on their ability to capture the interaction clearly. The second weight may be assigned to the camera 108 in a similar manner as described above. In an embodiment, the weighting unit 216 may be further configured to store the first and second weights in the storage element 118.

The action designator 218 may be coupled to the action detector 212 and the storage element 118. The action designator 218 may include suitable logic, circuitry, interfaces, and/or code, executable by the circuitry, that may be configured to perform one or more operations. For example, the action designator 218 may be configured to retrieve the first and second weights from the storage element 118. Further, the action designator 218 may be configured to select one of the cameras 106 and 108 for the recognition of the action of the user 120 based on the first and second weights. The action designator 218 may be further configured to designate the action detected using the selected camera to the user 120. The action designator 218 may be further configured to designate actions to the user 122 in a similar manner as described above for the user 120.

The re-identification unit 220 may be coupled to the action designator 218. The re-identification unit 220 may include suitable logic, circuitry, interfaces, and/or code, executable by the circuitry, that may be configured to perform one or more operations. For example, the re-identification unit 220 may be configured to re-identify the user 120 using one or more re-identification techniques. Based on the re-identification, various operations associated with the user 120 may be executed. For example, based on the successful re-identification and the action corresponding to a pick-up of the first product, the re-identification unit 220 may be further configured to associate the first product with a user account of the re-identified user 120.

The use of a bounding box-based approach in combination with adaptive camera weighting, forward-backward trajectory analysis, and multi-camera aggregation creates a unique, synergistic system that optimizes computational efficiency while maintaining precision, seamlessly integrates occlusion handling and action recognition into a unified framework, and resolves multi-user conflicts in dynamic, crowded environments. The action detection and recognition technique of the present disclosure integrates multi-camera inputs in real-time, balancing occlusion handling with temporal consistency to accurately classify actions like pick-up and putback.

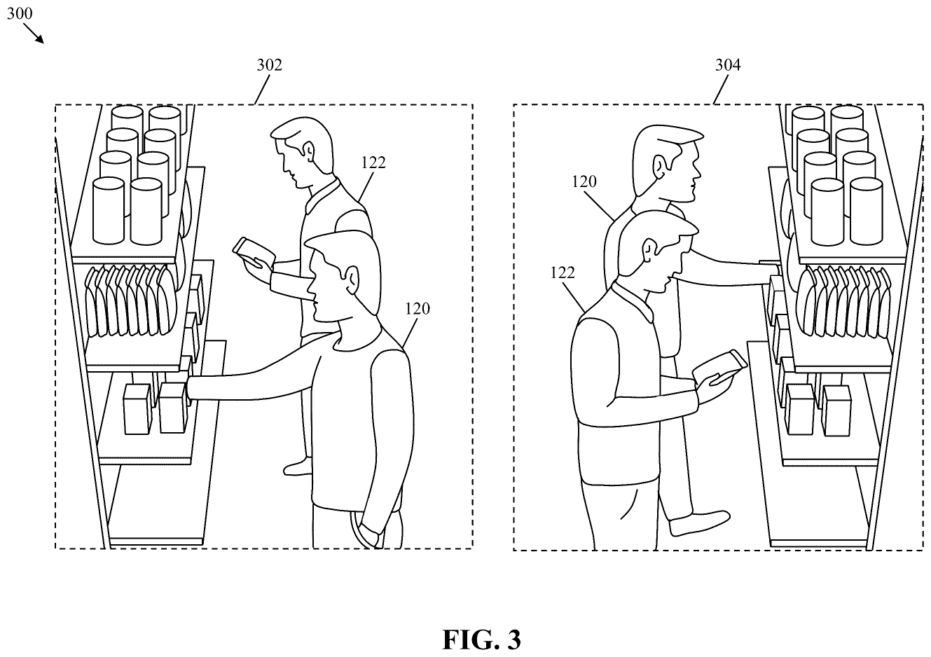

FIG. 3 represents an example scenario of the action detection and recognition technique, consistent with disclosed embodiments of the present disclosure. In FIG. 3, video frames 302 and 304 captured by the cameras 106 and 108, respectively, are illustrated. As illustrated in the video frame 302, the visibility of the user 120 is significantly better than that of the user 122. Conversely, in the video frame 304, the visibility of the user 122 is significantly better than that of the user 120. Thus, for the user 120, the camera 106 may be assigned a higher weight as compared to the camera 108, whereas for the user 122, the camera 108 may be assigned a higher weight as compared to the camera 106. Such weighting of the cameras 106 and 108 ensures that the camera with a better vantage point is selected for the action recognition for each user.

In FIG. 3, racks and products are not labeled to keep the illustrations concise and clear, and should not be considered a limitation of the present disclosure.

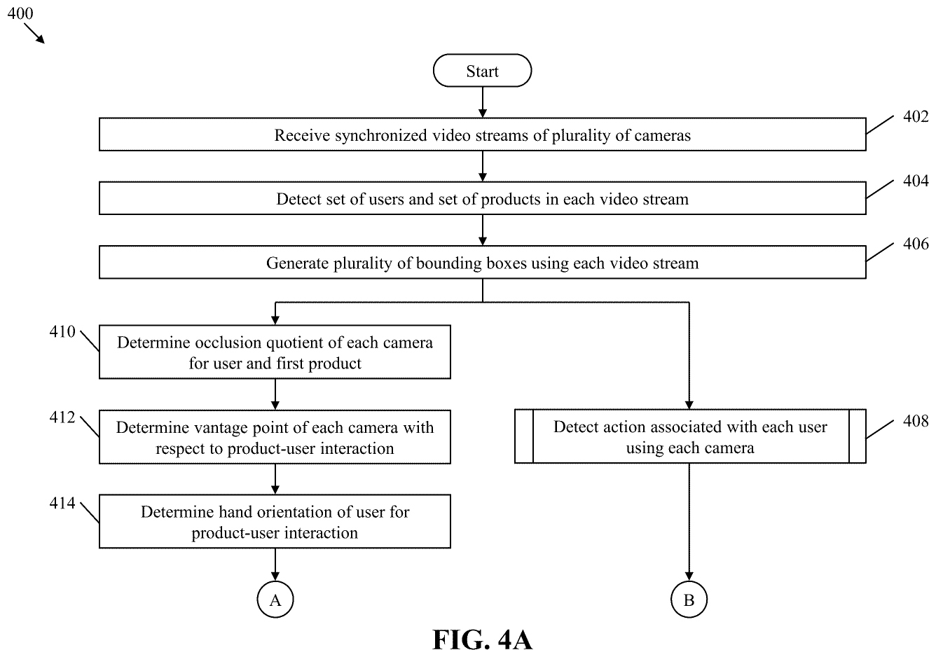

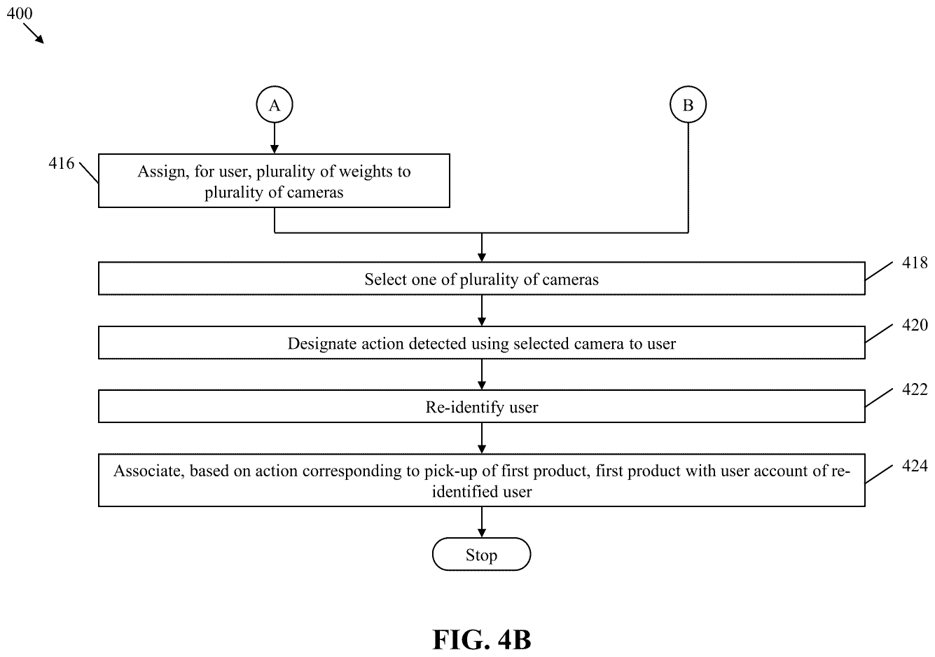

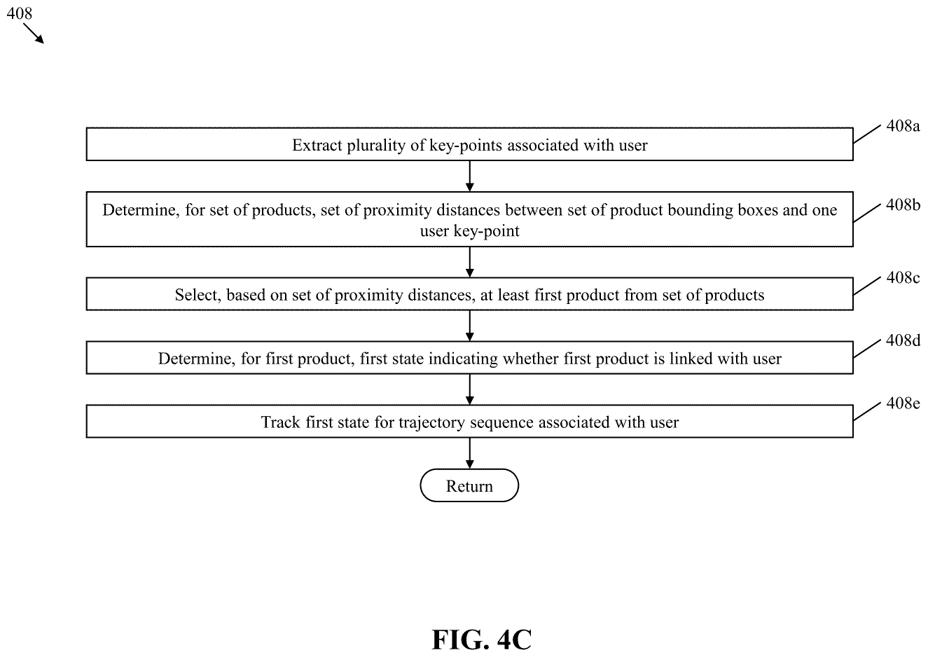

FIGS. 4A-4C, collectively, represents a flowchart 400 that illustrates a method for action detection and recognition, consistent with disclosed embodiments of the present disclosure.

Referring to FIG. 4A, at 402, the processing circuitry 114 may receive synchronized video streams of the plurality of cameras (e.g., the cameras 106 and 108). At 404, the processing circuitry 114 may detect a set of users and a set of products in each video stream. The set of users may correspond to the users 120 and 122. At 406, the processing circuitry 114 may generate a plurality of bounding boxes using each video stream. The plurality of bounding boxes may include user bounding boxes representing the users 120 and 122, and product bounding boxes representing the set of products. At 408, the processing circuitry 114 may detect action associated with each user using each camera. The action detection is described in FIG. 4C.

Referring to FIG. 4C, at 408a, the processing circuitry 114 may extract a plurality of key-points associated with a user (e.g., the user 120). At 408b, the processing circuitry 114 may determine, for the set of products, a set of proximity distances between the set of product bounding boxes and one user key-point. The user key-point may be the knuckle or fingertip key-point. At 408c, the processing circuitry 114 may select, based on the set of proximity distances, at least the first product from the set of products. At 408d, the processing circuitry 114 may determine, for the first product, the first state indicating whether the first product is linked with the user 120. At 408e, the processing circuitry 114 may track the first state for a trajectory sequence associated with the user 120. 408a-408e may be executed using a video stream of one camera (e.g., the camera 106).

The action performed by the user 120 is detected based on the tracked first state. The detected action may correspond to one of a pick-up of the first product from the rack 104 by the user 120 or a putback of the first product on the rack 104 by the user 120. In an embodiment, when the first product is absent in the hand of the user 120 in the forward trajectory and present in the hand of the user 120 in the backward trajectory, the action corresponds to the pick-up of the first product from the rack 104 by the user 120. Conversely, when the first product is present in the hand of the user 120 in the forward trajectory and absent in the hand of the user 120 in the backward trajectory, the action corresponds to the putback of the first product on the rack 104 by the user 120.

Referring back to FIG. 4A, at 410, the processing circuitry 114 may determine an occlusion quotient for each camera for the user 120 and the first product. For the user 120, the occlusion quotient corresponds to a ratio of (i) the overlap of the first user bounding box with the other bounding boxes in the video stream of the camera 106 and (ii) the total area of the first user bounding box. For the first product, the occlusion quotient corresponds to a ratio of (i) the overlap of the first product bounding box with the other bounding boxes in the video stream of the camera 106 and (ii) the total area of the first product bounding box.

At 412, the processing circuitry 114 may determine a vantage point of each camera with respect to product-user interaction. The product-user interaction may correspond to the interaction between the user 120 and the first product. At 414, the processing circuitry 114 may determine a hand orientation of the user 120 for the product-user interaction.

Referring to FIG. 4B, at 416, the processing circuitry 114 may assign, for the user 120, a plurality of weights (e.g., the first and second weights) to the plurality of cameras (e.g., the cameras 106 and 108, respectively). The first weight may be assigned based on the occlusion quotient of the camera 108 for the user 120 and the first product, the vantage point of the camera 106 with respect to the product-user interaction, and the hand orientation of the user 120 for the product-user interaction. 410-416 and 408 may be executed simultaneously.

Although it is described that the first weight may be assigned based on the occlusion quotient of the camera 108 for the user 120 and the first product, the vantage point of the camera 106 with respect to the product-user interaction, and the hand orientation of the user 120 for the product-user interaction, the scope of the present disclosure is not limited to it. In several embodiments, 412 and 414 may be skipped. In other words, the first weight may be assigned exclusively based on the occlusion quotient of the camera 108 for the user 120 and the first product, without deviating from the scope of the present disclosure.

At 418, the processing circuitry 114 may select one of the plurality of cameras. The processing circuitry 114 may select one of the cameras 106 and 108 based on the first and second weights. At 420, the processing circuitry 114 may designate the action detected using the selected camera to the user 120. At 422, the processing circuitry 114 may re-identify the user 120. At 424, the processing circuitry 114 may associate, based on the action corresponding to a pick-up of the first product, the first product with a user account of the re-identified user 120. In some embodiments, the processing circuitry 114 may remove, based on the action corresponding to a put-back of the first product, the association of the first product from user account of the re-identified user 120. At the time of billing, the products that are associated with the user account are considered for billing.

The action detection and recognition technique of the present disclosure thus provides a domain-specific, computationally efficient framework that integrates adaptive occlusion-aware camera weighting, bounding box-based analysis, hierarchical temporal-spatial aggregation, and trajectory-based multi-user action tracking. The action detection and recognition technique of the present disclosure addresses challenges in multi-camera, multi-user environments, offering a robust, non-obvious approach to detecting user actions even in the presence of occlusions and overlapping interactions.

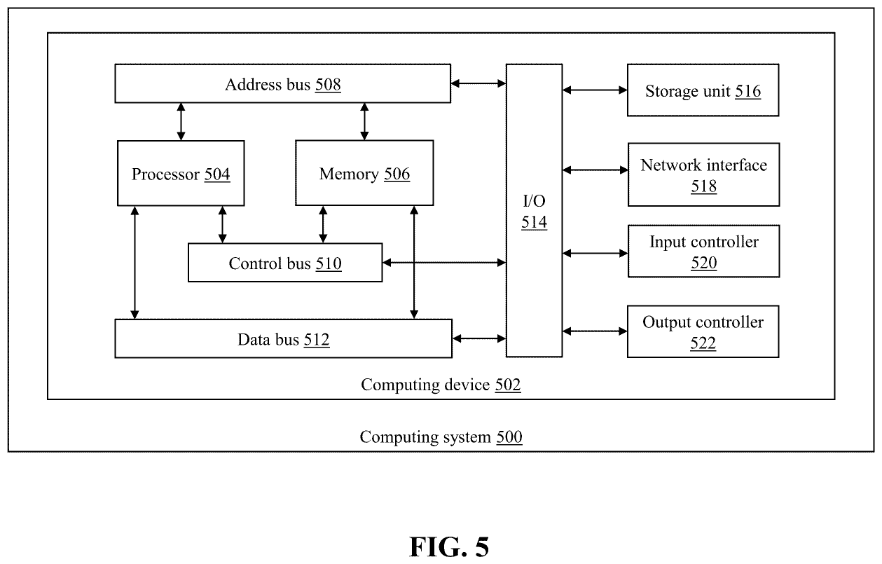

FIG. 5 shows an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 can be implemented as a conventional computer system, an embedded controller, a laptop, a server, a mobile device, a smartphone, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, and a data bus 512.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access-memory (RAM), a static random-access-memory (SRAM), a dynamic random-access-memory (DRAM), and a synchronous dynamic random-access-memory (SDRAM). The memory 506 may include single or multiple memory modules. While the memory 506 is depicted as part of the computing device 502, a person skilled in the art will recognize that the memory 506 can be separate from the computing device 502.

The memory 506 may store information that can be accessed by the processor 504. For instance, the memory 506 (e.g., one or more non-transitory computer-readable storage mediums, memory devices) may include computer-readable instructions (not shown) that can be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that when executed by the processor 504 cause the processor 504 to perform operations such as any of the operations and functions for which the computing system 500 is configured, as described herein. Additionally, or alternatively, the memory 506 may store data (not shown) that can be obtained, received, accessed, written, manipulated, created, and/or stored. The data can include, for instance, the data and/or information described herein in relation to FIGS. 1-4. In some implementations, the computing device 502 may obtain from and/or store data in one or more memory device(s) that are remote from the computing system 500.

The computing device 502 may further include an input/output (I/O) interface 514 communicatively coupled to the address bus 508, the control bus 510, and the data bus 512. The data bus 512 may include a plurality of tunnels that may support communication in the environment 100. The I/O interface 514 is configured to couple to one or more external devices (e.g., to receive and send data from/to one or more external devices). Such external devices, along with the various internal devices, may also be known as peripheral devices. The I/O interface 514 may include both electrical and physical connections for operably coupling the various peripheral devices to the computing device 502. The I/O interface 514 may be configured to communicate data, addresses, and control signals between the peripheral devices and the computing device 502. The I/O interface 514 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 514 is configured to implement only one interface or bus technology. Alternatively, the I/O interface 514 is configured to implement multiple interfaces or bus technologies. The I/O interface 514 may include one or more buffers for buffering transmissions between one or more external devices, internal devices, the computing device 502, or the processor 504. The I/O interface 514 may couple the computing device 502 to various input devices, including touch screens, scanners, biometric readers, electronic digitizers, receivers, touchpads, cameras, keyboards, any other pointing devices, or any combinations thereof. The I/O interface 514 may couple the computing device 502 to various output devices, including printers, projectors, tactile feedback devices, automation control, robotic components, actuators, transmitters, signal emitters, lights, and so forth.

The computing system 500 may further include a storage unit 516, a network interface 518, an input controller 520, and an output controller 522. The storage unit 516, the network interface 518, the input controller 520, and the output controller 522 are communicatively coupled to the central control unit (e.g., the memory 506, the address bus 508, the control bus 510, and the data bus 512) via the I/O interface 514. The network interface 518 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 518 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 516 is a computer-readable medium, preferably a non-transitory computer-readable medium, comprising one or more programs, the one or more programs comprising instructions which when executed by the processor 504 cause the computing system 500 to perform the method steps of the present disclosure. Alternatively, the storage unit 516 is a transitory computer-readable medium. The storage unit 516 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 516 stores one or more operating systems, application programs, program modules, data, or any other information. The storage unit 516 is part of the computing device 502. Alternatively, the storage unit 516 is part of one or more other computing machines that are in communication with the computing device 502, such as servers, database servers, cloud storage, network attached storage, and so forth.

The input controller 520 may include suitable logic, circuitry, interfaces, and/or code, executable by the circuitry, that may be configured to control one or more input devices that may be configured to receive camera video streams. The output controller 522 may include suitable logic, circuitry, interfaces, and/or code, executable by the circuitry, that may be configured to control one or more output devices that may be configured to output detected actions, re-identified users, and linked products.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for occlusion-resilient multi-camera action detection and recognition. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

1. A system, comprising:
processing circuitry configured to:
detect a user in each of a plurality of video streams of a plurality of cameras, wherein a first video stream comprises a plurality of frames;
generate, using each of the plurality of video streams, a plurality of bounding boxes, with a first bounding box representing the user and a first set of bounding boxes representing a set of products present in the corresponding video stream;
detect, using each of the plurality of video streams, an action associated with the user, wherein to detect the action using the first video stream of the plurality of video streams, the processing circuitry is further configured to:
extract a plurality of key-points associated with the user;
determine, for the set of products present in the first video stream, a set of proximity distances between the first set of bounding boxes and a first key-point of the plurality of key-points, wherein the set of proximity distances is determined for each frame of the plurality of frames;
select, based on the set of proximity distances, at least a first product from the set of products;
determine, for the first product, a first state indicating whether the first product is linked with the user;
track the first state for a trajectory sequence associated with the user, wherein the action is detected based on the tracked first state;
select one of the plurality of cameras based on a visibility of the first bounding box and an overlap associated with the first bounding box, in each video stream of the plurality of video streams; and
designate the action detected using the selected camera to the user.

2. The system of claim 1, wherein the action corresponds to one of a pick-up of the first product from a rack by the user or a putback of the first product on the rack by the user.

3. The system of claim 1, wherein the first key-point of the plurality of key-points corresponds to a knuckle of the user or a fingertip of the user.

4. The system of claim 1,
wherein the first product is associated with a rack,
wherein the processing circuitry is further configured to determine whether a set of key-points, of the plurality of key-points, representing a hand of the user, is present within a region between an interaction line and the rack, and
wherein the first state is determined and tracked based on the set of key-points being within the region between the interaction line and the rack.

5. The system of claim 4, wherein the trajectory sequence comprises:
a forward trajectory that corresponds to movement of the set of key-points from the interaction line to the rack, and
a backward trajectory that corresponds to movement of the set of key-points from the rack to the interaction line.

6. The system of claim 5,
wherein the first product is linked with the user if the first product is present in the hand of the user,
wherein when the first product is absent in the hand of the user in the forward trajectory and present in the hand of the user in the backward trajectory, the action corresponds to a pick-up of the first product from the rack by the user, and
wherein when the first product is present in the hand of the user in the forward trajectory and absent in the hand of the user in the backward trajectory, the action corresponds to a putback of the first product on the rack by the user.

7. The system of claim 6, wherein the first product is present in the hand of the user for at least a predefined time duration.

8. The system of claim 6, wherein the processing circuitry determines that the first product is in the hand of the user based on at least one of:
a proximity distance between a second bounding box, of the first set of bounding boxes, representing the first product and the first key-point being below a distance threshold, or
an overlap between the second bounding box and the first bounding box being above an overlap threshold.

9. The system of claim 1,
wherein the processing circuitry is further configured to assign, for the user, a plurality of weights to the plurality of cameras, with a first weight assigned to a first camera that is associated with the first video stream,
wherein the first weight is assigned to the first camera based on (i) the visibility of the first bounding box in the first video stream, and (ii) the overlap of the first bounding box with one or more other bounding boxes of the plurality of bounding boxes in the first video stream, and
wherein the processing circuitry selects one of the plurality of cameras based on the plurality of weights.

10. The system of claim 9, wherein a weight, of the plurality of weights, assigned to the selected camera is above a weight threshold.

11. The system of claim 9, wherein a weight assigned to the selected camera is the highest among the plurality of weights.

12. The system of claim 9,
wherein a set of key-points, of the plurality of key-points, represents a hand of the user, and
wherein the first weight is assigned to the first camera further based on a vantage point of the first camera with respect to an interaction of the hand of the user with the first product.

13. The system of claim 12, wherein the first weight is assigned to the first camera further based on an orientation of the hand of the user.

14. The system of claim 9,
wherein a second bounding box, of the first set of bounding boxes, represents the first product, and
wherein the first weight is assigned to the first camera further based on (i) a visibility of the second bounding box in the first video stream, and (ii) an overlap of the second bounding box with at least one other bounding box of the plurality of bounding boxes in the first video stream.

15. The system of claim 14, wherein the first weight is assigned to the first camera further based on a vantage point of the first camera with respect to the second bounding box.

16. The system of claim 1, wherein the plurality of video streams are synchronized using Network Time Protocol (NTP).

17. The system of claim 1, wherein a proximity distance of the set of proximity distances corresponds to a distance between a centroid of a bounding box of the first set of bounding boxes and the first key-point.

18. The system of claim 1, wherein the processing circuitry selects one of the plurality of cameras further based on a vantage point of each of the plurality of cameras with respect to an interaction of the user with the first product.

19. The system of claim 1, wherein the processing circuitry is further configured to:
re-identify the user; and
associate, based on the action corresponding to a pick-up of the first product, the first product with a user account of the re-identified user.

20. A method, comprising:
detecting, by processing circuitry, a user in each of a plurality of video streams of a plurality of cameras, wherein a first video stream comprises a plurality of frames;
generating, by the processing circuitry, using each of the plurality of video streams, a plurality of bounding boxes, with a first bounding box representing the user and a first set of bounding boxes representing a set of products present in the corresponding video stream;
detecting, by the processing circuitry, using each of the plurality of video streams, an action associated with the user, wherein the step of the detection of the action using the first video stream of the plurality of video streams further comprises:
extracting, by the processing circuitry, a plurality of key-points associated with the user;
determining, by the processing circuitry, for the set of products present in the first video stream, a set of proximity distances between the first set of bounding boxes and a first key-point of the plurality of key-points, wherein the set of proximity distances is determined for each frame of the plurality of frames;
selecting, by the processing circuitry, based on the set of proximity distances, at least a first product from the set of products;
determining, by the processing circuitry, for the first product, a first state indicating whether the first product is linked with the user;
tracking, by the processing circuitry, the first state for a trajectory sequence associated with the user, wherein the action is detected based on the tracked first state;
selecting, by the processing circuitry, one of the plurality of cameras based on a visibility of the first bounding box and an overlap associated with the first bounding box, in each video stream of the plurality of video streams; and
designating, by the processing circuitry, the action detected using the selected camera to the user.
